(19) United States
(12) Patent Application Publication
(10) Pub. No.: US 2009/0201463 A1
(43) Pub. Date: Aug. 13, 2009

(54) INSERTABLE CUT BLADE-STYLE EYEGLASS LENSES

(76) Inventor: Kevin Carlson, Atlantic Beach, FL (US)

Correspondence Address: MARK YOUNG, P.A., 12086 FORT CAROLINE ROAD, UNIT 202, JACKSONVILLE, FL, 32225, US

(21) Appl. No.: 12/030,206

(22) Filed: Feb. 13, 2008

(51) Int. Cl. G02C 7/02; B29D 11/00

(52) U.S. Cl. 351/174; 264/2.7

(57) ABSTRACT

A non-uniform thickness lens has a portion of a peripheral edge trimmed for secure engagement within a groove of blade style frame. Frame parameters are determined, such as by tracing the frame. The frame parameters include the plan layout as well as the contour and width of the engagement groove in the frame. The lens is edged to match the plan shape of the frame. The edged lens is then milled to reduce the thickness of the edge of each lens to a determined thickness along the contour corresponding to the non visual portion of the edge of the lens that will be engaged within the frame. The milled lens will fit securely in place in a blade style frame and without impairing the wearer's vision.

### FIELD OF THE INVENTION

This invention relates to eyewear, and, more particularly, to a lens with a portion of the peripheral edge trimmed for secure engagement within a groove of blade style frame, and to methods for making the same.

### BACKGROUND

As is well known, eyewear, such as corrective eyeglasses and sunglasses comprise two lenses that may be ophthalmic correcting lenses and/or sunglass lenses that are fitted to a frame which is designed to be placed on the bridge of a wearer's nose in such a manner as to position one lens appropriately in front of each eye. While many lenses are fixed permanently to the frame, some are not.

Conventional frame mounting techniques generally provide satisfactory results from the standpoint of positioning lenses accurately in front of the eye. However, the installation of lenses in conventional frames tends to be difficult to accomplish, requires special tooling and results in an assembly that compromises peripheral visibility. Furthermore, such installed lenses cannot be replaced except by performing a complex operation that exceeds the capability of most wearers lacking expertise in eyewear assembly.

One type of non-permanent mounting that has recently gained popularity is known as blade-style mounting. Blade-style frames feature grooved rims configured to engage a sufficient portion of the peripheral edge of an inserted lens that has been cut out to the corresponding frame plan shape. As the groove features a constant predetermined width, blade style frames have heretofore been limited to use with non-corrective lenses that feature a corresponding uniform thickness configured to fit in the groove or corrective lenses that have been adapted with an insert. Corrective lenses which vary in thickness and curvature along their periphery do not fit in the groove.

Consequently, most blade style frames are inserted into the frame part at the top of the lens only. Most use polycarbonate lenses or CR39 lenses. Due to the consistent width of the groove, blade-style frames have not been used with prescription lenses, unless the lenses are attached to an insert on the inside of the frame. What makes blade-style frames popular is that they have no frame in the wearer's vision from the sides and the bottom of the lens and they are aesthetically pleasing. However, a prescription insert compromises visibility, relegating the wearer to a much smaller lens with a frame around all sides of the lens. Additionally, inserts are unsightly.

What is needed is an aesthetically pleasing and inconspicuous means to adapt corrective lenses for use in blade-style frames. The invention is directed to overcoming one or more of the problems and solving one or more of the needs as set forth above.

### SUMMARY OF THE INVENTION

An object of the invention is to provide a lens with a portion of the peripheral edge trimmed for secure engagement within a groove of blade style frame. Another object of the invention is to provide methods for making the same. To achieve these objects and solve one or more of the problems set forth above, in an exemplary implementation of the invention, frame parameters are determined, such as by tracing the frame. The frame parameters include the plan layout as well as the contour and width of the engagement groove in the frame. Next, lenses are edged to match the plan shape of the frame. The edged lenses are then milled to reduce the thickness of the edge of each lens to a determined thickness along the contour corresponding to the non visual portion of the edge of the lens that will be engaged within the frame. The milled lenses will fit securely in place in a blade style frame and without impairing the wearer's vision.

In one aspect of an exemplary implementation of the invention, a non-uniform thickness optical lens is milled along an upper edge to fit within a groove of a blade style frame, the lens including an un-edged visual area and a milled edge portion configured to fit within the groove. The non-uniform thickness optical lens may include a milled edge portion having a thickness approximately equal to the width of the groove. The non-uniform thickness optical lens may include a milled edge portion having a depth less than the depth of the groove. The non-uniform thickness optical lens may include a milled edge portion having a shape approximately the same as the shape of the groove. The non-uniform thickness optical lens may include a milled edge portion having a thickness approximately equal to the width of the groove and a depth less than the depth of the groove. The non-uniform thickness optical lens may include a milled edge portion having a thickness approximately equal to the width of the groove, a depth less than the depth of the groove and a plan shape approximately the same as the shape of the groove. The non-uniform thickness optical lens may include a milled edge portion having a thickness equal to 1.0 to 0.75 times the width of the groove. The non-uniform thickness optical lens may include a milled edge portion having a depth equal to 1.0 to 0.50 times the depth of the groove. The non-uniform thickness optical lens may include a milled edge portion having a thickness equal to 1.0 to 0.75 times the width of the groove and a depth equal to 1.0 to 0.50 times the depth of the groove. The non-uniform thickness optical lens may include a milled edge portion having a thickness equal to 1.0 to 0.75 times the width of the groove and a depth equal to 1.0 to 0.50 times the depth of the groove, and a plan shape approximately the same as the shape of the groove.

In another aspect of an exemplary implementation of the invention, a method of producing a non-uniform thickness optical lens milled along an upper edge to fit within a groove of a blade style frame includes steps of determining a depth, width and shape of the frame and groove, edging the lens to the shape of the frame, and milling an edge of the lens to fit within the groove. In another aspect of an exemplary implementation of the invention, a method of producing a non-uniform thickness optical lens includes a step of milling including cutting an edge portion to a thickness approximately equal to the width of the groove. In another aspect of an exemplary implementation of the invention, a method of producing a non-uniform thickness optical lens includes a step of milling including cutting an edge portion to the depth less than the depth of the groove. In another aspect of an exemplary implementation of the invention, a method of producing a non-uniform thickness optical lens includes a step of milling including cutting an edge portion to the shape of the groove. In another aspect of an exemplary implementation of the invention, a method of producing a non-uniform thickness optical lens includes a step of milling including cutting an edge portion to a thickness approximately equal to the width of the groove and a depth less than the depth of the groove. In another aspect of an exemplary implementation of the invention, a method of producing a non-uniform thickness optical lens includes a step of milling including cutting an edge portion to a depth less than the depth of the groove, a thickness approximately equal to the width of the groove, and a plan shape approximately the same as the shape of the groove. In another aspect of an exemplary implementation of the invention, a method of producing a non-uniform thickness optical lens includes a step of milling including cutting an edge portion to a thickness equal to 1.0 to 0.75 times the width of the groove. In another aspect of an exemplary implementation of the invention, a method of producing a non-uniform thickness optical lens includes a step of milling including cutting an edge portion to a depth equal to 1.0 to 0.50 times the depth of the groove. In another aspect of an exemplary implementation of the invention, a method of producing a non-uniform thickness optical lens includes a step of milling including cutting an edge portion to a thickness equal to 1.0 to 0.75 times the width of the groove and a depth equal to 1.0 to 0.50 times the depth of the groove. In another aspect of an exemplary implementation of the invention, a method of producing a non-uniform thickness optical lens includes a step of milling including cutting an edge portion to a thickness equal to 1.0 to 0.75 times the width of the groove and a depth equal to 1.0 to 0.50 times the depth of the groove, and a plan shape approximately the same as the shape of the groove.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a top plan view of a lens blank with a dotted outline of a portion to be cut to form a lens having a plan shape that fits an exemplary blade-style frame, in accordance with principles of the invention;

FIG. 2 shows a top plan view of a lens cut from the lens blank in FIG. 1 to form a lens having a plan shape that fits an exemplary blade-style frame, in accordance with principles of the invention;

FIG. 3 shows a perspective view of a lens cut from the lens blank in FIG. 1 to form a lens having a plan shape that fits an exemplary blade-style frame, in accordance with principles of the invention;

FIG. 4 shows a top plan view of a lens cut from the lens blank in FIG. 1 with a milled upper edge to form a lens having a plan shape and upper edge thickness and contour that fits an exemplary blade-style frame, in accordance with principles of the invention;

FIG. 5 shows a perspective view of a lens cut from the lens blank in FIG. 1 with a milled upper edge to form a lens having a plan shape and upper edge thickness and contour that fits an exemplary blade-style frame, in accordance with principles of the invention; and this can be done on the front base curve of the prescription lens but generally will be done on the back base curve of the prescription lens for more of an aesthetically pleasing look and hiding the thickness of the prescription from the front of the lens.

FIG. 6 provides a perspective view of an exemplary blade-style frame, in accordance with principles of the invention; and

FIG. 7 provides a profile cross-section view of a portion of an exemplary blade-style frame and a corresponding portion of an exemplary edged and milled lens, in accordance with principles of the invention; and

FIG. 8 provides a high level block diagram of components of an exemplary system for producing lenses with portions of the peripheral edges trimmed for secure engagement within grooves of blade style frames in accordance with principles of the invention; and

FIG. 9 provides a high level flowchart of an exemplary method for producing lenses with portions of the peripheral edges trimmed for secure engagement within grooves of blade style frames in accordance with principles of the invention. The process for trimming the edge of prescription lenses is generally called edging or glazing in the optical business and the process for cutting the back curve of the lens to create the prescription is generally called surfacing in the optical business. The process shown in FIGS. 4 and 5 is a new process referred to herein as milling, which in one manner edges the base curve of the lens to match the same spherical curve of the front spherical curve to a desired thickness needed to fit into the groove of the blade frame. This process of the invention would in essence be edging the base curve of the previously surfaced curvatures of the required individual prescription. Each prescription can be completely different curvatures so each cut using the new invention will remove different amounts of material each time to fit the individual and unique prescription into different blade frame shapes which will also vary the cut and amount of material used.

Those skilled in the art will appreciate that the figures are not intended to be drawn to any particular scale; nor are the figures intended to illustrate every embodiment of the invention. The invention is not limited to the exemplary embodiments depicted in the figures or the frames, lenses, shapes, relative sizes, ornamental aspects or proportions shown in the figures.

### DETAILED DESCRIPTION

Referring to the Figures, in which like parts are indicated with the same reference numerals, various views of an exemplary lens, frame and eyewear assembly according to principles of the invention are shown. The term “lens” is used herein for convenience to refer to any lens, whether it is corrective or non-corrective. The invention is not limited to the lens shown in the Figures. The term “frame” is use herein to refer to any frame with a uniform thickness grove for receiving all or a portion of the periphery of a lens, without regard to the aesthetics, overall shape and size, and ornamental features of the frames, without regard to sex or age of the wearer.

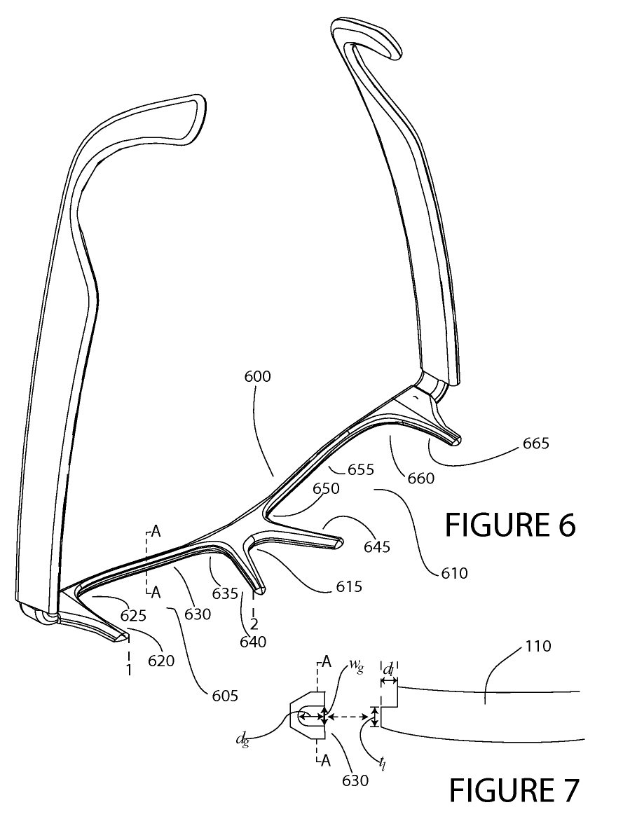

The manufacture of eyeglass lenses according to principles of the invention is a multi-step process. In the case of corrective lenses, the process may commence with an eye exam during which a patient's condition is assessed to derive a prescription for each eye. After a prescription is determined, a frame may be selected. In the case of the invention, the chosen frame is a blade-style frame, such as the exemplary blade-style frame 600 shown in FIG. 6. Next, the frame 600 is measured or traced for a required size and shape of the lenses to fit therein. Generally, a tracer, as known in the art, may be used to acquire information about the shape of the frame. Such tracers typically have means (i.e., an engagement probe) for engaging the object, as well as means for moving the probe along the object while the position of the frame engager is monitored. The resulting position information then is used to determine the shape of the frame. Linear actuated tracers which provide movement/position detection with respect to orthogonal X- and Y-axes, pivotally actuated tracers which provide movement/position detection with respect to a rotational axis, and any other means suitable for defining the shape of a frame may be utilized within the scope of the invention. Alternatively, a template or predetermined specifications may be created or provided to define the required size and shape of the lenses to fit within the frame.

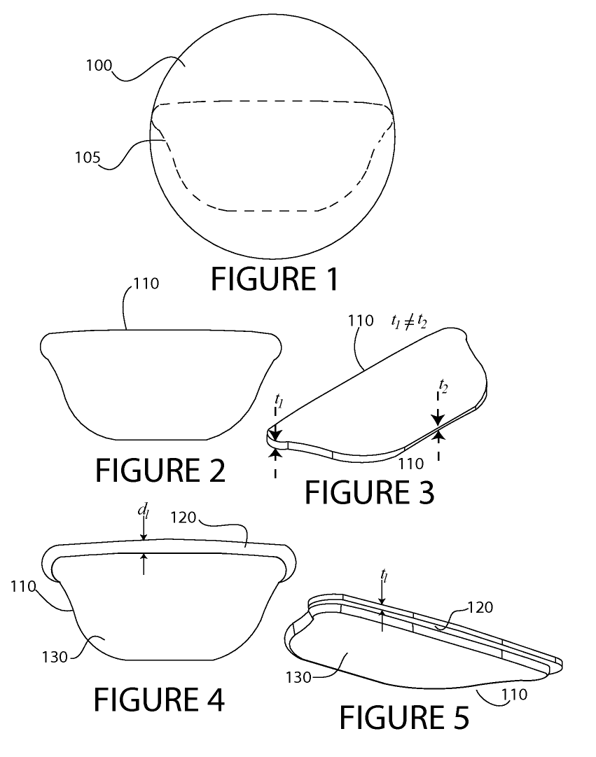

Subsequently, a lens blank may be selected for each eye, which will accommodate the prescription for each eye and the frame. Referring now to FIG. 1, a top plan view of a lens blank with a dotted outline of a portion to be cut to form a lens having a plan shape that fits an exemplary blade-style frame, in accordance with principles of the invention, is shown. The lens blank may be injection-molded from plastic and have a standardized, finished convex outer surface with a spherical or progressive shape, for example. Each lens blank may be characterized by lens blank parameters which include the material from which the blank is made, such as acrylic, polycarbonate or other plastic materials, the optical parameters which define the contour of the front and rear surfaces, which can include its diopter values, decentration of the optical center and cylindrical axis orientation. Even non-prescription lens blanks can be said to have such parameters though they may have zero optical power values. While most prescriptions can be filled by commercially available finished lens blanks without further grinding and polishing of the optical surfaces, occasionally a prescription may necessitate grounding and polishing to provide desired front and back surface shapes.

Each selected lens blank is processed according to its optical parameters and the prescription parameters in equipment configured to machine the blank into an optically correct lens. Such processing can include a grinding step to shape the front and/or back surfaces of the lens, polishing the surfaces, and or cutting away material from the lens blank so that the finished lens may fit the selected eyeglass frame, and tinting the lenses for sunglasses. The inner surface or prescription surface, which is usually concave, may have a spherical, aspherical, toric, atoric, progressive or free-form geometry (e.g. progressive surfaces) by means of a machining operation to remove material, depending on the desired optical effect. The typical conventional procedure during the machining of inner surfaces provides that a cutting or turning machining process is carried out to produce the optically active shape, usually followed by a fine grinding or polishing process to achieve the required surface quality.

In general, most corrective lenses fall into one of two categories, namely spherical lenses or cylindrical lenses, each being suited to correct different eye conditions. A spherical lens blank is typically shaped to have a convex front surface, a concave rear surface, and a circular perimeter having a lower edge which lies in a plane substantially perpendicular to a central axis. Each spherical lens blank is typically sized to be about 3 inches (7.5 centimeters) in diameter and has a thickness contour which allows it to serve as a lens stock for a wide variety of eyeglass frames. Cylindrical lenses differ from spherical lenses by the curvature of surfaces varying according to meridian or angular direction from the central axis. Accordingly, the edge may have a saddle shape, with different thicknesses t₁ and t₂ at different points along the lens.

Referring now to FIG. 1, a lens blank 1 is “edged” or cut along a path whose shape is generally defined by the shape of the selected blade-style frame. Such frames come in numerous shapes, primarily dictated by fashion. Thus, by edging a blank 100 along the dotted path 105 shown in FIG. 1, the edged lens 110 as shown in FIGS. 2 and 3 is produced. FIG. 2 shows a top plan view of a lens 110 cut from the lens blank 100 along the dotted line 105 in FIG. 1 to form a lens having a plan shape that fits an exemplary blade-style frame 600, in accordance with principles of the invention. FIG. 3 shows a perspective view of the lens 110 cut from the lens blank 100 in FIG. 1. The edged lens 110 may have a non-uniform shape, with different thicknesses t₁ and t₂ at different points along the edge of the lens.

In order for a non-uniform thickness lens 110 to be installed in a blade-style frame 600 in accordance with principles of the invention, the configuration (i.e., shape, depth and width) of the groove is determined, so that an engaged edge of the lens may be properly milled to fit within the engaging portion of a frame, such as the exemplary frame 600 shown in FIG. 6. The exemplary frame 600 is designed with a nosepiece 615 to be placed on the bridge of a wearer's nose in such a manner as to position one lens appropriately in front of each eye. With further reference to FIGS. 6 and 7, the shape of each groove from 1 at 620 to the curve at 625 along 630 to the curve at 635 and then 640 to 2 is traced. A similar shape is determined for the other lens of the pair, from 645 to the curve at 650 along 655 to the curve at 660 and then to 665. The depth of the groove, d_{g}, and the thickness or width of the groove, w_{g}, are also determined.

The frame data, i.e., the shape of the groove, depth of the groove, d_{g}, and the thickness or width of the groove, w_{g}, are used to create an upper edge 120 of lesser thickness than at least part of the un-edged visual area 130, as shown in FIGS. 4 and 5, that fits within the groove of the frame 600. FIG. 4 shows a top plan view of a lens 110 cut from the lens blank 100 in FIG. 1 with a milled upper edge 120 to form a lens edge 120 having a plan shape and thickness and contour that fits an exemplary blade-style frame, in accordance with principles of the invention. The edge 120 of the lens 110 corresponding to and shaped like the groove 630 is milled (e.g., cut, abraded and/or removed by laser) to depth, dₗ, corresponding to (i.e., about equal to or slightly smaller than) the depth of the groove, d_{g}. Likewise, edge of the lens 110 corresponding to and shaped like the groove 630 is milled to thickness, tₗ, corresponding to (i.e., about equal to or slightly smaller than) the width of the groove, w_{g}. Milling can be performed on the front base curve of the prescription lens but generally will be done on the back base curve of the prescription lens for more of an aesthetically pleasing look and hiding the thickness of the prescription from the front of the lens.

FIG. 7 provides a profile cross-section view of a section A-A of an exemplary blade-style frame 600 and a corresponding portion of an exemplary edged and milled lens 110, in accordance with principles of the invention. The edge 120 of the lens 110 corresponding to and shaped like the groove 630 is milled (e.g., cut, abraded and/or removed by laser) to depth, dₗ, corresponding to (i.e., about equal to or slightly smaller than) the depth of the groove, d_{g}. Likewise, edge of the lens 110 corresponding to and shaped like the groove 630 is milled to thickness, tₗ, corresponding to (i.e., about equal to or slightly smaller than) the width of the groove, w_{g}. The milled edge 120 may fit easily within the groove or require some urging to fit snugly within the grove.

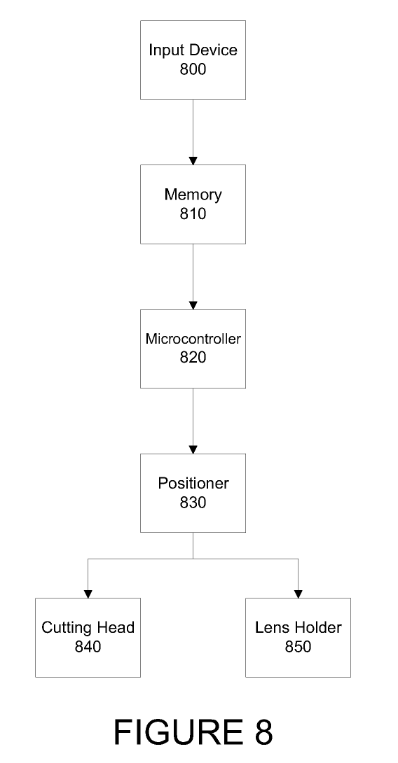

FIG. 8 provides a high level block diagram of components of an exemplary system for producing lenses with portions of the peripheral edges trimmed for secure engagement within grooves of blade style frames in accordance with principles of the invention. An input device 800 facilitates user control. Data sets may be stored in a storage means such as a volatile or nonvolatile memory 810 or mass storage device. The edging of the lens blank may be accomplished by the precise control of the movement of a mechanical or optical (e.g., laser) cutter along a locus or path on the surface of the lens blank. This path may be determined by tracing and utilized in a software program running on a microcontroller 820 which, in turn, controls a positioned 830 the moves of the cutting head 840 relative to the lens 110 held in a lens holder 850. The positioner 830 may move the cutting head 840 on a carriage or axis relative to the lens holder 850 and/or keep the cutting head 840 stationary while the lens holder 850 moves. The software program accesses and interprets one or more data sets stored in memory 810 containing the various parameters which will determine the shape, depth and thickness along the locus or path defining the milled edge 120. The data set of frame parameters may be derived from a database generated by a tracer, a CAD system or other source, and generally dictates the overall shape the completed lens must have in order to properly mount within the chosen blade-style frame.

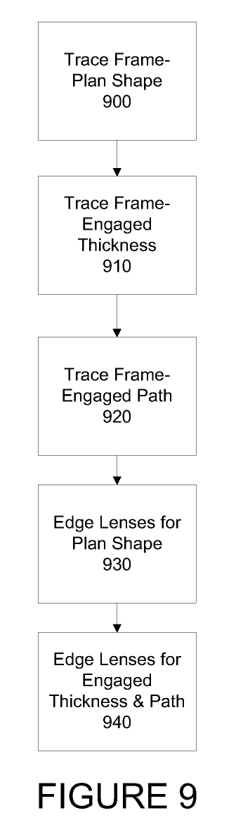

FIG. 9 provides a high level flowchart of an exemplary method for producing lenses with portions of the peripheral edges trimmed for secure engagement within grooves of blade style frames in accordance with principles of the invention. The process for trimming the edge of prescription lenses is generally called edging or glazing in the optical business and the process for cutting the back curve of the lens to create the prescription is generally called surfacing in the optical business. The process shown in FIGS. 4 and 5 is a new process referred to herein as milling, which in one manner edges the base curve of the lens to match the same spherical curve of the front spherical curve to a desired thickness needed to fit into the groove of the blade frame. This process of the invention would in essence be edging the base curve of the previously surfaced curvatures of the required individual prescription. Each prescription can be completely different curvatures so each cut using the new invention will remove different amounts of material each time to fit the individual and unique prescription into different blade frame shapes which will also vary the cut and amount of material used. The frame plan shape 800, engaged edge thickness 810 and engaged path 820 (i.e., starting, ending and intermediate points, depth and shape) are determined. The lens is edged to the plan shape 830 and then milled to the thickness and path 840. The edging and milling are accomplished by the precise control of the relative movement of a cutter along a locus or path on the surface of the lens.

The software system for guiding the cutter relative to the lens comprises routines which generally prepare the data sets necessary to direct the cutter along a cutting path for each lens in a processing run. The routines generally access the data sets from a database or from other inputs including, for example, a separate tracer for the frame parameters, and/or the operator. The routines may allow for the operator to make changes or enter parameters which may not have otherwise been entered including etching depth data or texturing data. The system then calculates a cutting path from the accepted parameter data sets which can include power settings, velocity, and pitch, roll and yaw data of the cutter with respect to the bed.

In sum, in one aspect of an exemplary implementation of the invention, a non-uniform thickness optical lens is milled along an upper edge to fit within a groove of a blade style frame, the lens including an un-edged visual area and a milled edge portion configured to fit within the groove. The non-uniform thickness optical lens may include a milled edge portion having a thickness approximately equal to the width of the groove. The non-uniform thickness optical lens may include a milled edge portion having a depth less than the depth of the groove. The non-uniform thickness optical lens may include a milled edge portion having a shape approximately the same as the shape of the groove. The non-uniform thickness optical lens may include a milled edge portion having a thickness approximately equal to the width of the groove and a depth less than the depth of the groove. The non-uniform thickness optical lens may include a milled edge portion having a thickness approximately equal to the width of the groove, a depth less than the depth of the groove and a plan shape approximately the same as the shape of the groove. The non-uniform thickness optical lens may include a milled edge portion having a thickness equal to 1.0 to 0.75 times the width of the groove. The non-uniform thickness optical lens may include a milled edge portion having a depth equal to 1.0 to 0.50 times the depth of the groove. The non-uniform thickness optical lens may include a milled edge portion having a thickness equal to 1.0 to 0.75 times the width of the groove and a depth equal to 1.0 to 0.50 times the depth of the groove. The non-uniform thickness optical lens may include a milled edge portion having a thickness equal to 1.0 to 0.75 times the width of the groove and a depth equal to 1.0 to 0.50 times the depth of the groove, and a plan shape approximately the same as the shape of the groove.

In another aspect of an exemplary implementation of the invention, a method of producing a non-uniform thickness optical lens milled along an upper edge to fit within a groove of a blade style frame includes steps of determining a depth, width and shape of the frame and groove, edging the lens to the shape of the frame, and milling an edge of the lens to fit within the groove. The method of producing a non-uniform thickness optical lens may include a step of milling including cutting an edge portion to a thickness approximately equal to the width of the groove. The method of producing a non-uniform thickness optical lens may include a step of milling including cutting an edge portion to the depth less than the depth of the groove. The method of producing a non-uniform thickness optical lens may include a step of milling including cutting an edge portion to the shape of the groove. The method of producing a non-uniform thickness optical lens may include a step of milling including cutting an edge portion to a thickness approximately equal to the width of the groove and a depth less than the depth of the groove. The method of producing a non-uniform thickness optical lens may include a step of milling including cutting an edge portion to a depth less than the depth of the groove, a thickness approximately equal to the width of the groove, and a plan shape approximately the same as the shape of the groove. The method of producing a non-uniform thickness optical lens may include a step of milling including cutting an edge portion to a thickness equal to 1.0 to 0.75 times the width of the groove. The method of producing a non-uniform thickness optical lens may include a step of milling including cutting an edge portion to a depth equal to 1.0 to 0.50 times the depth of the groove. The method of producing a non-uniform thickness optical lens may include a step of milling including cutting an edge portion to a thickness equal to 1.0 to 0.75 times the width of the groove and a depth equal to 1.0 to 0.50 times the depth of the groove. The method of producing a non-uniform thickness optical lens may include a step of milling including cutting an edge portion to a thickness equal to 1.0 to 0.75 times the width of the groove and a depth equal to 1.0 to 0.50 times the depth of the groove, and a plan shape approximately the same as the shape of the groove.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A non-uniform thickness optical lens milled along an upper edge to fit within a groove of a blade style frame, said lens comprising an un-edged visual area and a milled edge portion configured to fit within the groove.

2. A non-uniform thickness optical lens according to claim 1, said milled edge portion having a thickness approximately equal to the width of the groove.

3. A non-uniform thickness optical lens according to claim 1, said milled edge portion having a depth less than the depth of the groove.

4. A non-uniform thickness optical lens according to claim 1, said milled edge portion having a shape approximately the same as the shape of the groove.

5. A non-uniform thickness optical lens according to claim 1, said milled edge portion having a thickness approximately equal to the width of the groove and a depth less than the depth of the groove.

6. A non-uniform thickness optical lens according to claim 1, said milled edge portion having a thickness approximately equal to the width of the groove, a depth less than the depth of the groove and a plan shape approximately the same as the shape of the groove.

7. A non-uniform thickness optical lens according to claim 1, said milled edge portion having a thickness equal to 1.0 to 0.75 times the width of the groove.

8. A non-uniform thickness optical lens according to claim 1, said milled edge portion having a depth equal to 1.0 to 0.50 times the depth of the groove.

9. A non-uniform thickness optical lens according to claim 1, said milled edge portion having a thickness equal to 1.0 to 0.75 times the width of the groove and a depth equal to 1.0 to 0.50 times the depth of the groove.

10. A non-uniform thickness optical lens according to claim 1, said milled edge portion having a thickness equal to 1.0 to 0.75 times the width of the groove and a depth equal to 1.0 to 0.50 times the depth of the groove, and a plan shape approximately the same as the shape of the groove.

11. A method of producing a non-uniform thickness optical lens milled along an upper edge to fit within a groove of a blade style frame, said method comprising steps of determining a depth, width and shape of the frame and groove, edging the lens to the shape of the frame, and milling an edge of the lens to fit within the groove.

12. A method of producing a non-uniform thickness optical lens according to claim 11, said step of milling comprising cutting an edge portion to a thickness approximately equal to the width of the groove.

13. A method of producing a non-uniform thickness optical lens according to claim 11, said step of milling comprising cutting an edge portion to the depth less than the depth of the groove.

14. A method of producing a non-uniform thickness optical lens according to claim 11, said step of milling comprising cutting an edge portion to the shape of the groove.

15. A method of producing a non-uniform thickness optical lens according to claim 11, said step of milling comprising cutting an edge portion to a thickness approximately equal to the width of the groove and a depth less than the depth of the groove.

16. A method of producing a non-uniform thickness optical lens according to claim 11, said step of milling comprising cutting an edge portion to a depth less than the depth of the groove, a thickness approximately equal to the width of the groove, and a plan shape approximately the same as the shape of the groove.

17. A method of producing a non-uniform thickness optical lens according to claim 11, said step of milling comprising cutting an edge portion to a thickness equal to 1.0 to 0.75 times the width of the groove.

18. A method of producing a non-uniform thickness optical lens according to claim 11, said step of milling comprising cutting an edge portion to a depth equal to 1.0 to 0.50 times the depth of the groove.

19. A method of producing a non-uniform thickness optical lens according to claim 11, said step of milling comprising cutting an edge portion to a thickness equal to 1.0 to 0.75 times the width of the groove and a depth equal to 1.0 to 0.50 times the depth of the groove.

20. A method of producing a non-uniform thickness optical lens according to claim 11, said step of milling comprising cutting an edge portion to a thickness equal to 1.0 to 0.75 times the width of the groove and a depth equal to 1.0 to 0.50 times the depth of the groove, and a plan shape approximately the same as the shape of the groove.
